(19) United States
(12) Patent Application Publication
(10) Pub. No.: US 2013/0039402 A1
(43) Pub. Date: Feb. 14, 2013

(54) METHOD TO GET A FREQUENCY REFERENCE TO A BASE STATION

(71) Applicants: Ulf Skärby, Lidingo (SE); Karl-Gösta Sahlman, Sollentuna (SE)

(72) Inventors: Ulf Skärby, Lidingo (SE); Karl-Gösta Sahlman, Sollentuna (SE)

(73) Assignee: TELEFONAKTIEBOLAGET L M ERICSSON (PUBL), Stockholm (SE)

(21) Appl. No.: 13/642,715

(22) PCT Filed: Apr. 21, 2010
(86) PCT No.: PCT/SE2010/050438

§ 371 Date: Oct. 22, 2012

(51) Int. Cl. H04W 88/08; H04B 1/38

(52) U.S. Cl. 375/222; 375/219

(57) ABSTRACT

The present solution relates to a method in a base station (110) for generating radio frequency. The base station (110) comprises a base station unit (125) connected to a tower mounted amplifier (122) via a feeder (127). A signal from the base station unit (125) is received, via a serial interface over the feeder (127), in the tower mounted amplifier (122). A frequency reference signal is extracted from the received signal. The extracted frequency reference signal is provided to a radio frequency synthesizer (210). The radio frequency synthesizer (210) is comprised in the tower mounted amplifier (122). A radio frequency is generated in the radio frequency synthesizer (210) using the extracted reference signal.

### TECHNICAL FIELD

This invention relates generally to an antenna device and a method in base station. More particularly this invention relates to radio frequency generation.

### BACKGROUND

In a typical cellular system, also referred to as a wireless communications network, wireless terminals, also known as mobile stations and/or User Equipment units (UEs) communicate via a Radio Access Network (RAN) to one or more core networks. The wireless terminals may be mobile stations or user equipment units such as mobile telephones also known as “cellular” telephones, and laptops with wireless capability, e.g., mobile termination, and thus may be, for example, portable, pocket, hand-held, computer-included, or car-mounted mobile devices which communicate voice and/or data with radio access network.

The radio access network covers a geographical area which is divided into cell areas. Each cell area being served by a base station, e.g., a Radio Base Station (RBS), which in some networks is also called NodeB or evolved NodeB and which in this document also is referred to as a base station. A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units within range of the base stations. The base station comprises equipment for transmitting and receiving radio signals, such as e.g. antenna devices.

In some versions of the radio access network, several base stations are typically connected, e.g. by landlines or microwave, to a Radio Network Controller (RNC). The radio network controller supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using Code Division Multiple Access (CDMA) for user equipment units. The Third Generation Partnership Project (3GPP) has undertaken to evolve further the UTRAN and GSM based radio access network technologies. In 3GPP this work regarding the 3G Long Term Evolution (LTE) system is ongoing.

In some applications in communication systems, it is necessary to convert frequencies in a base station. The frequency conversion has, in some cases, very high accuracy requirements. Examples of such applications are disclosed in US 2007/0191064 and WO 2007/086785. US 2007/0191064 describes using few feeders in between a RBS and an antenna diversity system, where radio signals received on antennas are frequency converted. WO 2007/086785 describes an omni-radio base station with multiple sector antenna units. At least one of the sector antenna units have an associated frequency converter that converts a carrier signal received by the antenna unit. In both these documents, the requirements for the conversion accuracy are very stringent.

In cases such as for example US 2007/0191064 and WO 2007/086785, the current solutions for achieving frequency conversations with high accuracy are to use a temperature stable crystal oscillator or sending a pilot tone in the feeder from the RBS.

The problems with a high accuracy crystal oscillator are that they are very expensive and that they lower the mean time between failure (MTBF), i.e. a reliability measure. In addition, the high accuracy oscillator is sensitive for vibration.

The problem with a pilot tone is that the RBS must always have the possibility to provide the pilot tone even if it is not used. This will drive the cost.

### SUMMARY

The objective problem is therefore to provide a less costly mechanism for providing high accuracy signals in a communication network.

According to a first aspect of the invention, the objective problem is solved by a method in a base station for generating radio frequency. The base station comprises a base station unit connected to a tower mounted amplifier via a feeder. The feeder comprises a serial interface configured to be used for antenna mounted equipment control and supervision. The tower mounted amplifier is comprised in the base station. A signal from the base station unit is received, in the tower mounted amplifier, over the feeder via the serial interface. A frequency reference signal is extracted from the received signal. The extracted frequency reference signal is provided to a radio frequency synthesizer. The radio frequency synthesizer is comprised in the tower mounted amplifier. A radio frequency is generated in the radio frequency synthesizer, using the extracted reference signal.

According to a second aspect of the invention, the objective problem is solved by a base station for generating radio frequency. The base station comprises a base station unit connected to a tower mounted amplifier via a feeder. The feeder comprises a serial interface configured to be used for antenna mounted equipment control and supervision. The tower mounted amplifier is comprised in the base station. The base station further comprises a receiving circuit configured to receive, in the tower mounted amplifier, a signal from the base station unit over the feeder via the serial interface. The base station comprises an extracting circuit which is coupled to the receiving circuit and configured to extract a frequency reference signal from the received signal. Further, the base station comprises a providing circuit which is coupled to the extracting circuit and configured to provide the extracted frequency reference signal to a radio frequency synthesizer. The radio frequency synthesizer is comprised in the tower mounted amplifier. The base station also comprises a generating circuit which is coupled to the providing circuit and configured to generate, in the radio frequency synthesizer, a radio frequency using the extracted reference signal.

Since the frequency reference signal is extracted from the received signal, and that the extracted frequency reference signal is provided to the radio frequency synthesizer, a radio frequency is generated in the radio frequency synthesizer, using the extracted reference signal. Thus, reducing the cost for providing high accuracy signals in a communication network.

Embodiments herein afford many advantages, for which a non-exhaustive list of examples follows:

Using an existing frequency reference signal involves lower cost than using for example a crystal oscillator or a pilot tone. Another advantage is that the mean time between failure is improved, which increase the reliability. Also, the advantage of reduced power consumption is achieved. The present solution does not require any extra hardware from the base station unit, in contrast to using a pilot tone, which always must be provided by the RBS, even if it is not used. The pilot tone requires band pass filters both on the RBS and on a Tower Mounted Amplifier (TMA). As the present solution does not use a pilot tone, these band pass filters are not necessary, i.e. reducing the complexity of the solution.

The present invention is not limited to the features and advantages mentioned above. A person skilled in the art will recognize additional features and advantages upon reading the following detailed description.

### BRIEF DESCRIPTION OF THE DRAWINGS

The invention will now be further described in more detail in the following detailed description by reference to the appended drawings illustrating embodiments of the invention and in which:

FIG. 1 is a schematic block diagram illustrating embodiments of a communication network.

FIG. 2 is a schematic block diagram illustrating embodiments of a base station.

FIG. 3 is a combined signaling and block diagram depicting embodiments of a method.

FIG. 4 is a schematic block diagram illustrating embodiments of accurate frequency generation in an antenna device.

FIG. 5 is a schematic block diagram illustrating embodiments of accurate frequency generation in an antenna device.

FIG. 6 is a schematic block diagram illustrating embodiments of a radio frequency (RF) loop in an antenna device.

FIG. 7 is a schematic block diagram illustrating embodiments of a method in a base station.

FIG. 8 is a schematic block diagram illustrating embodiments of a base station.

The drawings are not necessarily to scale, emphasize is instead being placed upon illustrating the principle of the invention.

### DETAILED DESCRIPTION

The basic concept of the present solution is to use an existing communication link, i.e. a serial interface, extract the clock from the existing communication link and use the extracted clock as a reference for radio frequency generation.

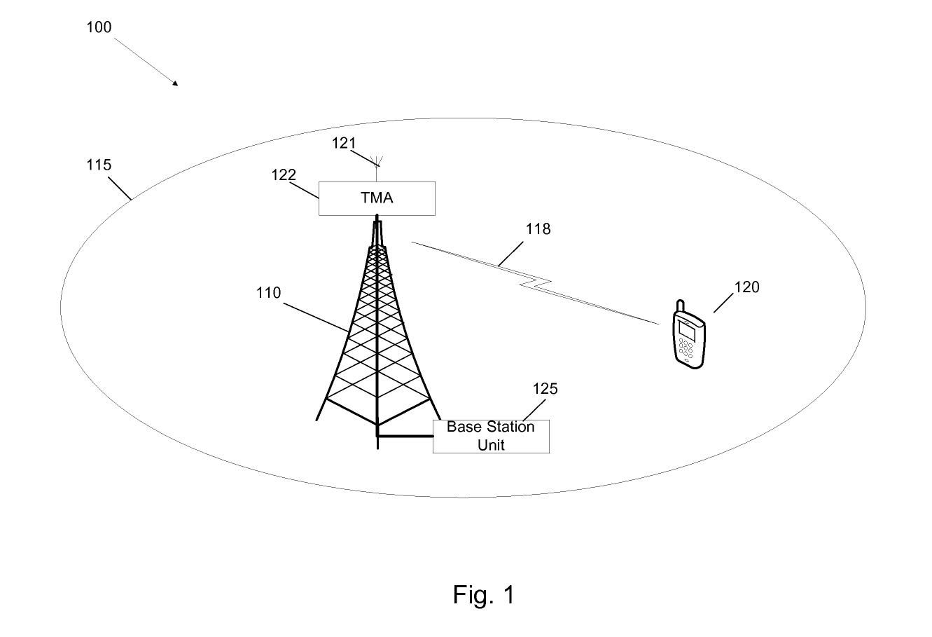

FIG. 1 depicts a communication network 100. The communication network 100 may use technologies such as Long Term Evolution (LTE), Global System for Mobile communication (GSM), Wideband Code Division Multiple Access (WCDMA) etc. The communication network 100 comprises a base station 110 serving a cell 115. The base station 110 may be a WCDMA, LTE or GSM base station, or any other network unit capable to communicate over a radio carrier 118 with a user equipment 120 being present in the serving cell 115. The base station 110 comprises an at least one antenna 121, a Tower Mounted Amplifier (TMA) 122 and a base station unit 125. The base station unit 125 may be e.g. located at the base of the base station 110. The antenna 121 is connected to the TMA 122. The TMA 122 may be mounted on the top of the base station 110, and coupled via a feeder cable 127, typically a coaxial cable or the like, to the base station unit 125.

The antenna 121 transforms wire lined signals to air signals and vice versa. The received signal suffers signal losses when traversing the feeder 127, and the taller the base station 110, the longer the feeder 127, and the greater the loss. In order to offset such signal losses in the feeder 127, a TMA 122 may be used to amplify the received signal before it is sent over the feeder 127 to the base station unit 125. TMA 122 is sometimes called a mast head amplifier. The term tower mounted amplifier is used generically herein to comprise any device that performs this pre-feeder amplification function. A TMA 122 may also comprise a Remote Electrical Tilt (RET) function.

The user equipment 120 which may be present within the cell 115, may be served by the base station 110, and is in this case capable of communicating with the base station 110 over the radio carrier 118.

The user equipment 120 may be any suitable communication device or computational device with communication capabilities capable to communicate with a base station over a radio channel, for instance but not limited to mobile phone, smart phone, personal digital assistant (PDA), laptop, MP3 player or portable DVD player or similar media content devices, digital camera, or even stationary devices such as a PC. A PC may also be connected via a mobile station as the end station of the broadcasted/multicasted media. The user equipment 120 is referred to as UE in some of the figures.

The user equipment 120 communicates with the base station 110 using any suitable radio protocol and communication protocol depending on radio access setup. The radio protocol is arranged so as to allow for packet based communication, e.g. using the Internet Protocol (IP) of any suitable version, e.g. version 4 or 6.

It should be appreciated that the networks are configured with cabling, routers, switches, and other network building elements (not shown) as understood by the skilled person, for instance as used for building an Ethernet or WAN network.

Today's radio base stations have design requirements which set demands on the communication over the feeder to the antenna devices comprised in a TMA, Remote Electrical Tilt (RET) etc. The communication is done with different methods, such as for example Frequency Shift Keying (FSK) or On Off Keying (OOK). The accuracy in the frequency for FSK or OOK does not have to be very stringent since e.g. it only must detect a frequency or not. But, since the base station 110 requires a very accurate clock for frequency generation of the carriers, this clock may be used to generate the frequency needed for FSK or OOK. There is a requirement for an accurate clock because without an accurate clock, a fault will be regarded as a Doppler shift. If the offset is too large, the frequency will land in another carrier, i.e. it will interfere with the adjacent carrier. The present solution therefore regenerates the clock from the FSK or OOK signal.

This may be done with a Phase Locked Loop (PLL) and necessary logic to generate a signal that has a fixed relation to the phase of a reference signal, i.e. to see if there is a 1 or 0. The logic is already implemented since the output from the FSK or OOK modem is available. The OOK or FSK modem in the TMA 122 will get a 1 or 0 as output depending on, if for the OOK there is a frequency or not, and for FSK if it is frequency 1 or frequency 2.

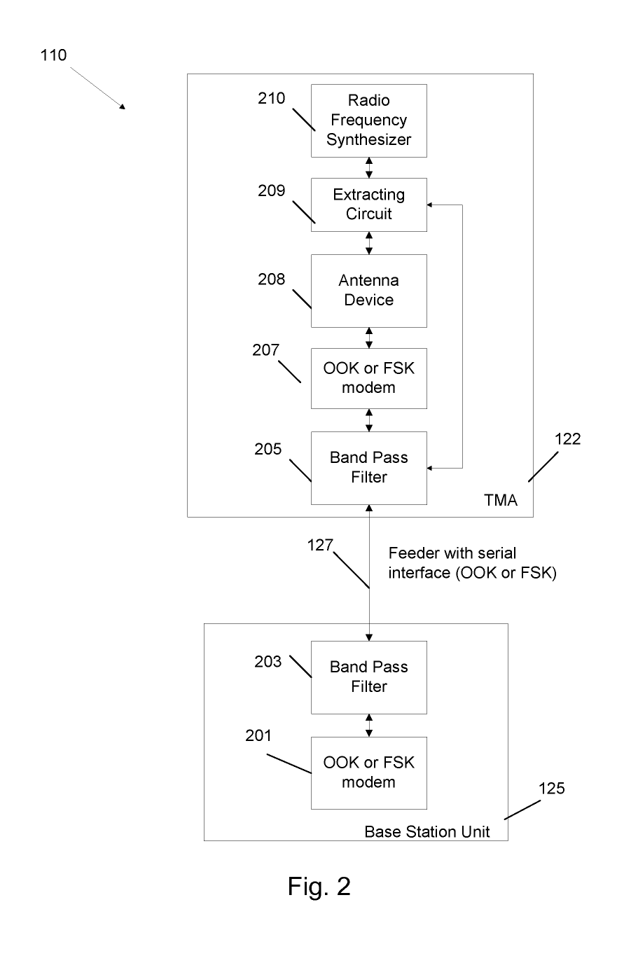

FIG. 2 illustrates a simplified basic configuration of a base station 110. As mentioned above, the base station 110 comprises a base station unit 125 and a TMA 122. In short, the base station unit 125 generates a signal which is transmitted to and received in the TMA 122. The TMA 122 uses this signal to generate data and to extract a reference signal, i.e. a clock. In more detail, the base station unit 125 comprises a modem 201, such as for example a FSK or OOK modem. The base station unit 125 further comprises a band pass filter 203 connected to the modem 201. The feeder 127 comprises a serial interface, such as a FSK or OOK interface and connects the base station unit 125 to the TMA 122. The modem 201 generates data, i.e. 1 or 0, from the serial interface. The TMA 122 comprises a band pass filter 205. The TMA 122 also comprises a modem 207 such as for example a FSK or OOK modem. An antenna device 208, and an extracting unit 209 which is connected to the modem 207 and to a radio frequency synthesizer 210. The band pass filter 205 may also be directly connected to the extracting circuit 209.

The base station 110 may comprise other components in addition to the ones illustrated in FIG. 2, such as for example further band pass filters and duplex filters etc. However, the shown components are only to illustrate the basic concept of the present solution.

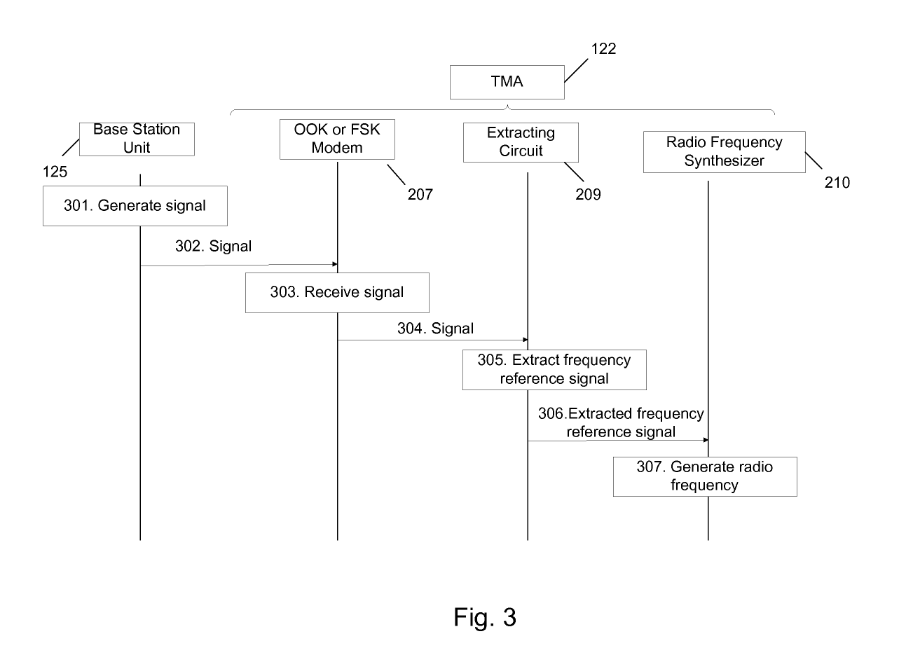

The present solution method for generating radio frequency, according to some embodiments will now be described with reference to the combined signaling diagram and flowchart depicted in FIG. 3 and with reference to FIG. 1 depicting the communication network 100 and FIG. 2 depicting the base station 110. The method comprises the following steps, which steps may as well be carried out in another suitable order than described below.

### Step 301

The base station unit 125 generates a signal, such as for example a status request signal. The status request may have the purpose of checking the status of the TMA 122.

The status request may be generated in the modem 201, such as an OOK or FSK modem, and is filtered in the band pass filter 203.

### Step 302

The base station unit 125 transmits the signal to the TMA 122 via the feeder 127. The feeder 127 has a serial interface, such as for example an OOK or FSK interface.

The signal may be transmitted periodically from the base station unit 125 to the TMA 122. Alternatively, RET is re-adjusted, i.e. the frequencies of the synthesizers are re-adjusted

### Step 303

The TMA 122 receives the signal sent over the feeder 127 via the serial interface. The signal may be an OOK or FSK signal, depending on the interface over which is sent. The signal may be received in the modem 207, which modulates the signal. Examples of modems 207 may be, as mentioned earlier, a phase looked loop for FSK or OOK, or a radio frequency loop.

Before modulating the signal, it may be filtered in the band pass filter 205.

### Step 304

The signal is sent to the extracting circuit 209.

### Step 305

The extracting circuit 209 extracts a frequency reference signal from serial interface, i.e. the received signal.

### Step 306

The extracted frequency references signal is provided to the radio frequency synthesizer 210.

### Step 305

The radio frequency synthesizer 210 uses the extracted frequency reference signal to generate a radio frequency.

As mentioned earlier, there are several applications in a communication network 100 that would benefit from the present solution, i.e. generation of radio frequency by using a frequency reference signal from a serial interface.

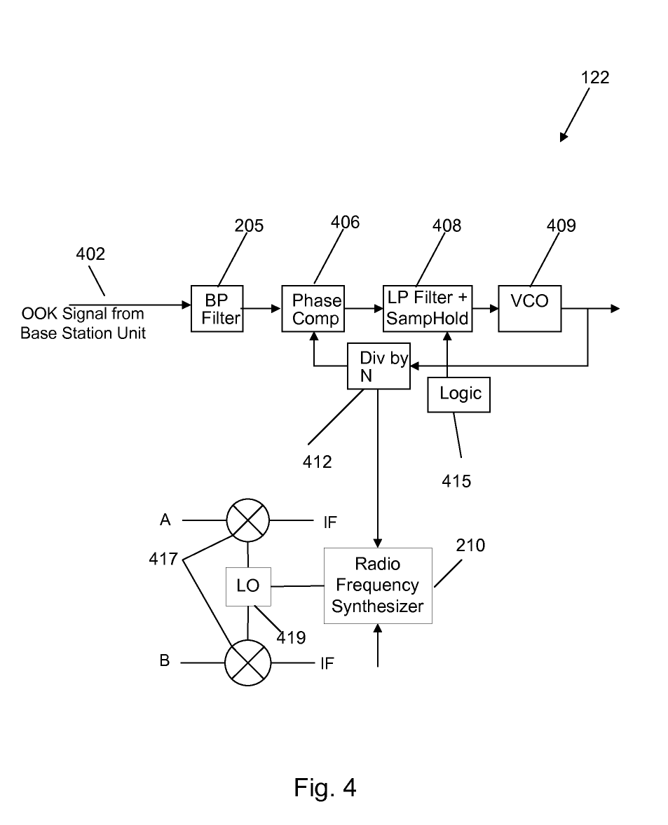

FIG. 4 illustrates an example of an application where the present solution may be used where the modems in the base station unit 125 and the TMA 122 are OOK modems. The figure illustrates a Phase Locked Loop (PLL) for OOK. A reference clock is extracted from an OOK data signal 402, and provided to a synthesizer 210 situated in the base station 110. The OOK signal 402 is input to a band pass filter 205. The band pass filter 205 is the same band pass filter 205 as shown in FIG. 2. The OOK signal 402 is generated in the base station unit 125 and inserted on the feeder 127. The OOK signal 402 is according to 3GPP with rather low bit rate. The band pass filter 205 filters the OOK signal. The filtered signals is compared in a phase comparator 406 together with another signal and produces an error signal which is proportional to their phase difference. The other signal will be described in more detail later. The error signals is low pass filtered and a sample-and-hold operation is performed on the error signal in the LP Filter+SampHold 408. The signal is then used to drive a voltage-controlled oscillator VCO 409, which creates an output frequency. The output frequency, i.e. the other signal, is fed through a frequency divider Div by N 412 back to the input of the phase comparator 406, producing a negative feedback loop. If the output frequency drifts, the error signal will increase, driving the VCO frequency in the opposite direction so as to reduce the error. Thus the output is locked to the frequency at the other input. This input is called the reference and is often derived from a crystal oscillator, which is very stable in frequency. The output of the PLL, i.e. the clock from the OOK signal 402 is regenerated, and a suitable frequency is provided from the Div by N 412 to for example the radio frequency synthesizer 210, which is in need of an accurate reference signal. Logic 415 is connected to the sample and Hold 408, and uses the data, i.e. 1 or 0, generated in the modem 401. The mixer 417 converts the RF (RX) signal to an intermediate frequency (IF). A local oscillator 419 ensures that the right shape of the signal is provided to the mixer 417.

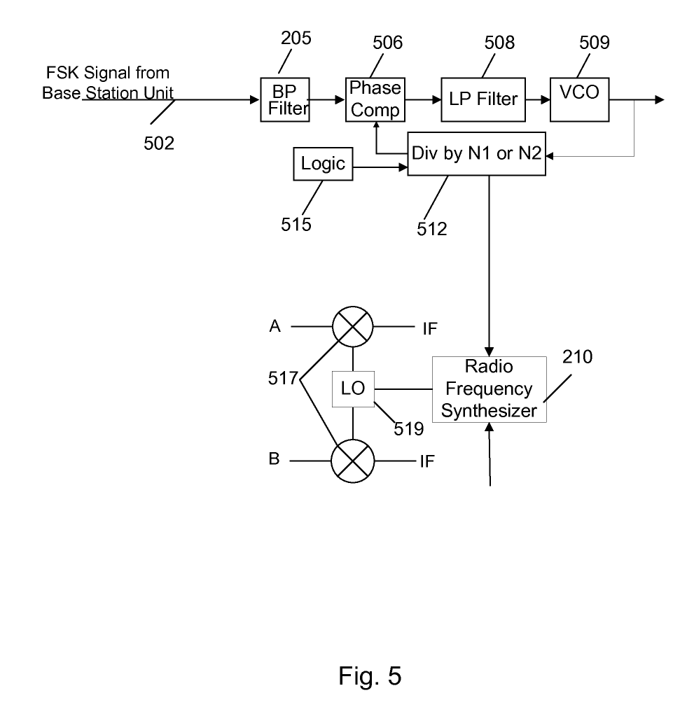

FIG. 5 illustrates another example of application of the present solution where the modems in the base station unit 125 and the TMA 122 are FSK modems. The figure illustrates a Phase Locked Loop (PLL) for FSK. A reference clock is extracted from a FSK data signal 502, and provided to a synthesizer 210 situated in the TMA 122. An FSK signal 502 is input to a band pass filter 205. The FSK signal 502 is generated in the base station unit 125 and inserted on the feeder 127. The band pass filter 205 filters the FSK signal 502. The filtered signals is compared in a phase comparator 506 together with another signal and produces an error signal which is proportional to their phase difference. The other signal will be described in more detail later. The error signals is low pass filtered in the LP Filter 508. The signal is then used to drive a voltage-controlled oscillator VCO 509, which creates an output frequency. The output frequency, i.e. the other signal, is fed through a frequency divider Div by N1 or N2 512 back to the input of the phase comparator 505, producing a negative feedback loop.

In the PLL for FSK, the feedback loop comprises a different frequency divider, Div by N1 or N2 512 than for OOK. Since the FSK modem has 2 frequencies, f1 and f2, representing 1 or 0, it means that the dividing must be different if f1 or f2 is sent from the RBS 110. Another difference is that the logic 515 is connected to the frequency divider 512, instead of the low pass filter 507. The output from the FSK modem in the TMA 122 controls if N1 or N2 value shall be used. The mixer 517 converts the RF (RX) signal to an intermediate frequency (IF). A local oscillator 519 ensures that the right shape of the signal is provided to the mixer 517.

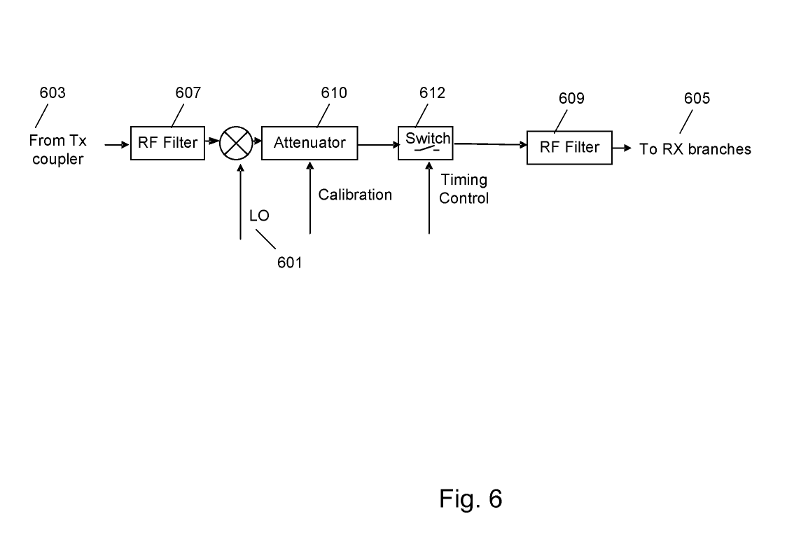

FIG. 6 illustrates another application where an accurate reference signal is needed. The LO 601 gets its frequency from a synthesizer. The synthesizer gets its reference frequency from a PLL, such as for example the PLL shown in FIG. 4 or 5. This figure shows a scenario where the whole Tx band is converted to the Rx band. A Radio Frequency (RF) Loop performs a frequency conversion of a small portion of a transmitted output power from a Tx coupler 603 and which loops this signal to receiver branches (Rx branch) 605 for testing purposes. The frequency conversion is done using two RF filters 607, 609, an attenuator 610 and a switch 612. The idea is in the TMA 122 to down convert a tiny part of the Tx output signal 603 into the base station Rx band 605. Changing the output power of the Radio Unit (RU) will vary the input signal to the receiver 605, so that the sensitivity threshold may be found. This will be a measure if the system works as intended. The Local Oscillator (LO) 601 requires a reference to be accurate and may use the present solution to get an accurate and cheap solution.

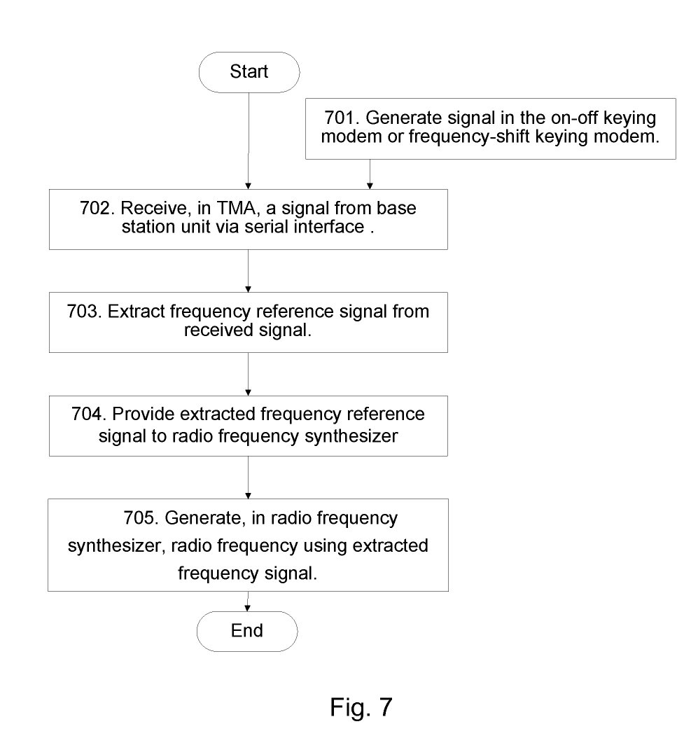

The method described above will now be described seen from the perspective of the base station 110. FIG. 7 is a flowchart describing the present method in the base station 110 for generating radio frequency. The base station 110 comprises a base station unit 125 connected to a tower mounted amplifier 122 via a feeder 127. The feeder 127 comprises a serial interface configured to be used for antenna mounted equipment control and supervision. The tower mounted amplifier 122 is comprised in the base station 110. The serial interface may be an on-off keying serial interface or a frequency-shift keying serial interface. The base station unit 125 may comprise an on-off keying modem or a frequency-shift keying modem.

The method comprises the following steps to be performed in the base station 110. The steps may as well be carried out in another suitable order than described below.

### Step 701

This is an optional step. A signal may be generated in the on-off keying modem or frequency-shift keying modem.

### Step 702

A signal is received in the tower mounted amplifier 122 from the base station unit 125 over the feeder 127 via the serial interface.

The received signal may be a status request signal.

### Step 703

The tower mounted amplifier 122 extracts a frequency reference signal from the received signal.

### Step 704

The extracted frequency reference signal is provided to a radio frequency synthesizer 210. The extracted frequency reference signal is in other words an external signal to the radio frequency synthesizer 210. The radio frequency synthesizer 210 is comprised in the tower mounted amplifier 122.

### Step 705

A radio frequency is generated in the radio frequency synthesizer 210 using the extracted reference signal.

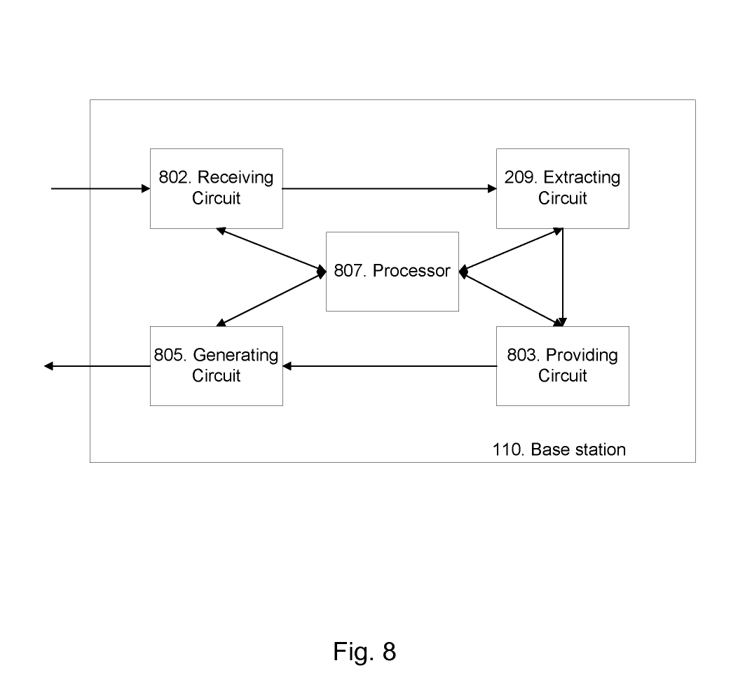

To perform the method steps shown in FIG. 7 for radio frequency generation the base station 110 comprises a base station arrangement as shown in FIG. 8. The base station 110 comprises a base station unit 125 connected to a tower mounted amplifier 122 via a feeder 127. The feeder 127 comprises a serial interface configured to be used for antenna mounted equipment control and supervision. The tower mounted amplifier 122 is comprised in the base station 110. The serial interface may be an on-off keying serial interface or a frequency-shift keying serial interface. The base station unit 125 may comprise an on-off keying modem or a frequency-shift keying modem.

The base station 110 may comprise a generating circuit 802 configured to generate the request signal in the on-off keying modem or frequency-shift keying modem.

The base station 110 further comprises a receiving circuit 802 configured to receive, in the tower mounted amplifier 122, a signal from the base station unit 125 over the feeder 127 via the serial interface. The received signal may be a status request signal.

The base station comprises an extracting circuit 209 coupled to the receiving circuit 209 and configured to extract a frequency reference signal from the received signal.

Further, the base station 110 comprises a providing circuit 803 coupled to the extracting circuit (209) configured to provide the extracted frequency reference signal to a radio frequency synthesizer 210. The extracted frequency reference signal is in other words an external signal to the radio frequency synthesizer 210. The radio frequency synthesizer 210 is comprised in the tower mounted amplifier 122.

The base station 110 also comprises a generating circuit 805 coupled to the providing circuit 803 and configured to generate, in the radio frequency synthesizer 210, a radio frequency using the extracted reference signal.

The present mechanism for radio frequency generation may be implemented through one or more processors, such as a processor 807 in the base station 110 depicted in FIG. 8, together with computer program code for performing the functions of the present solution. The processor may be for example a Digital Signal Processor (DSP), Application Specific Integrated Circuit (ASIC) processor, Field-programmable gate array (FPGA) processor or micro processor. The program code mentioned above may also be provided as a computer program product, for instance in the form of a data carrier carrying computer program code for performing the present solution when being loaded into the base station 110. One such carrier may be in the form of a CD ROM disc. The computer program code may furthermore be provided as pure program code on a server and downloaded to the base station 110 remotely via the e.g. OOK or FSK serial interface.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasised that the steps of the methods defined in the appended claims may, without departing from the present invention, be performed in another order than the order in which they appear in the claims.

The present solution is not limited to the above described preferred embodiments. Various alternatives, modifications and equivalents may be used. Therefore, the above embodiments should not be taken as limiting the scope of the invention, which is defined by the appending claims.

1. A method in a base station (110) for generating radio frequency, the base station (110) comprising a base station unit (125) connected to a tower mounted amplifier (122) via a feeder (127), which feeder (127) comprises a serial interface configured to be used for antenna mounted equipment control and supervision, the tower mounted amplifier (122) being comprised in the base station (110), the method comprising:
receiving (702), in the tower mounted amplifier (122), a signal from the base station unit (125) over the feeder (127) via the serial interface;
extracting (703) a frequency reference signal from the received signal;
providing (704) the extracted frequency reference signal to a radio frequency synthesizer (210), which radio frequency synthesizer (210) being comprised in the tower mounted amplifier (122); and
generating (705), in the radio frequency synthesizer (210), a radio frequency using the extracted reference signal.

2. The method according to claim 1, wherein the serial interface is an on-off keying serial interface or a frequency-shift keying serial interface.

3. The method according to any of the claims 1-2, wherein the received signal is a status request signal.

4. The method according to any of the claims 1-3,
wherein the base station unit (125) further comprises an on-off keying modem or a frequency-shift keying modem; and
wherein the method further comprising
generating (701) the signal in the on-off keying modem or frequency-shift keying modem.

5. The method according to any of the claims 1-4,
wherein the extracted frequency reference signal is an external signal to the radio frequency synthesizer (210).

6. A base station (110) for generating radio frequency, the base station (110) comprising a base station unit (125) connected to a tower mounted amplifier (122) via a feeder (127), which feeder (127) comprises a serial interface configured to be used for antenna mounted equipment control and supervision, the tower mounted amplifier (122) being comprised in the base station (110), the base station (110) further comprising:
a receiving circuit (802) configured to receive, in the tower mounted amplifier (122), a signal from the base station unit (125) over the feeder (127) via the serial interface;
an extracting circuit (209) coupled to the receiving circuit (802) and configured to extract a frequency reference signal from the received signal;
a providing circuit (803) coupled to the extracting circuit (209) and configured to provide the extracted frequency reference signal to a radio frequency synthesizer (210), which radio frequency synthesizer (210) being comprised in the tower mounted amplifier (122); and
a generating circuit (805) coupled to the providing circuit (803) and configured to generate, in the radio frequency synthesizer (210), a radio frequency using the extracted reference signal.

7. The base station (110) according to claim 6,
wherein the serial interface is an on-off keying serial interface or a frequency-shift keying serial interface.

8. The base station (110) according to any of the claims 6-7,
wherein the received signal is a status request signal.

9. The base station (110) according to any of the claims 6-8,
wherein the base station unit (125) further comprises an on-off keying modem or a frequency-shift keying modem; and
wherein the generating circuit (805) is configured to generate the signal in the on-off keying modem or frequency-shift keying modem.

10. The base station (110) according to any of the claims 6-9,
wherein the extracted frequency reference signal is an external signal to the radio frequency synthesizer (210).
